(19) United States
(12) Patent Application Publication
(10) Pub. No.: US 2011/0012792 A1
(43) Pub. Date: Jan. 20, 2011

(54) ANTENNA ARRANGEMENT FOR MULTIMODE COMMUNICATION DEVICE

(75) Inventors: Eric Krenz, Crystal Lake, IL (US); Bill Alberth, Prairie Grove, IL (US); Roger Scheer, Beach Park, IL (US)

Correspondence Address: MOTOROLA MOBILITY, INC, 600 NORTH US HIGHWAY 45, W2-55BB, LIBERTYVILLE, IL, 60048-5343, US

(73) Assignee: Motorola, Inc., Schaumburg, IL (US)

(21) Appl. No.: 12/505,044

(22) Filed: Jul. 17, 2009

(51) Int. Cl. H01Q 1/50; H01Q 1/24; H01Q 3/24; H01Q 1/38

(52) U.S. Cl. 343/702; 343/860; 343/876; 343/700 MS

(57) ABSTRACT

A multimode communication device (10 or 50) having an antenna arrangement (14 or 54) having a first antenna (18) operational in both low bands and high bands, a second antenna (20) operational in high bands, a tuner (26) coupled to the first antenna adapted to adjust matching elements to modify return loss to lower reflected power, a switching mechanism (28) for selecting between the first antenna and the second antenna, and a controller (30) coupled to the switching mechanism and the tuner.

### CROSS REFERENCE TO RELATED APPLICATIONS

U.S. patent application ______, Attorney Docket No. CS36402BLACK356 entitled “Split Band Diversity Antenna Arrangement”, and U.S. patent application ______, Attorney Docket No. CS36276ALBERTH362 entitled “Customized Antenna Arrangement”, both concurrently filed on Jul. 17, 2009 by the same Assignee herein.

### FIELD OF THE DISCLOSURE

This invention relates generally to antennas, and more particularly to a multiband antenna operating on several distinct bands.

### BACKGROUND

As wireless devices become exceedingly slimmer and greater demands are made for antennas operating on a diverse number of frequency bands, common antennas such as a Planar Inverted “F” Antenna (PIFA) design becomes impractical for use in such slim devices due to its inherent height requirements. Antenna configurations typically used for certain bands can easily interfere or couple with other antenna configurations used for other bands. Thus, designing antennas for operation across a number of diverse bands each band having a sufficient bandwidth of operation becomes a feat in artistry as well as utility, particularly when such arrangements must meet the volume requirements of today's smaller communication devices.

Another concern with antenna designs in general for multi-band phones includes optimized antenna performance across desired frequency bands. Existing designs may have call drop issues or poor performance that relate to loading on antennas caused by hand grips on a portion of the phone or caused by loading caused by other loading conditions. Furthermore, antennas designed for PCS bands are generally configured to be optimized across the entire PCS band which may not be ideal for a number of scenarios.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present disclosure.

FIG. 1 depicts an embodiment of a communication device and antenna arrangement in accordance with the present disclosure;

FIG. 2 depicts an alternative embodiment of the communication device and antenna arrangement of FIG. 1 in accordance with the present disclosure;

FIG. 3 is an antenna radiation/system efficiency chart illustrating VSWR tuning opportunities in accordance with the present disclosure;

FIG. 4 is a block diagram of a communication device with an antenna arrangement with a high band antenna on a top portion and a low band antenna on a bottom portion of the communication device in accordance with the present disclosure;

FIG. 5 is a flow chart illustrating a method of implementing a portion of the antenna arrangement in accordance with an embodiment of the present disclosure;

FIG. 6 is a graph illustrating antenna performance optimized for a portion of the PCS band in accordance with the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

One embodiment of the present disclosure can entail an antenna arrangement for a multimode communication device having a first antenna designed primarily for operation in a low band below 1000 MHz and in predetermined modes for high bands above 1500 MHz, a second antenna designed to operate solely or only in the high bands, a Voltage Standing Wave Ratio (VSWR) tuner coupled to the first antenna, and a controller coupled to the VSWR tuner. The antenna arrangement can also entail a switching mechanism for selecting between the first antenna and the second antenna where the controller would be coupled to the switching mechanism and the tuner.

Another embodiment of the present disclosure can entail a multimode communication device having an antenna arrangement having a first antenna designed for operation in both low bands and high bands, a second antenna designed to operate solely or only in high bands, a tuner coupled to the first antenna adapted to adjust matching elements to modify return loss to lower reflected power, a switching mechanism for selecting between the first antenna and the second antenna, and a controller coupled to the switching mechanism and the tuner.

Yet another embodiment of the present disclosure can entail an antenna arrangement for a multimode communication device having a tuner coupled to a first antenna adapted to adjust matching elements to modify return loss to lower reflected power where the antenna is designed for operation in both low bands and high bands, a switching mechanism for selecting between the first antenna and a second antenna, where the second antenna is designed to operate only in high bands, and a controller coupled to the switching mechanism and the tuner.

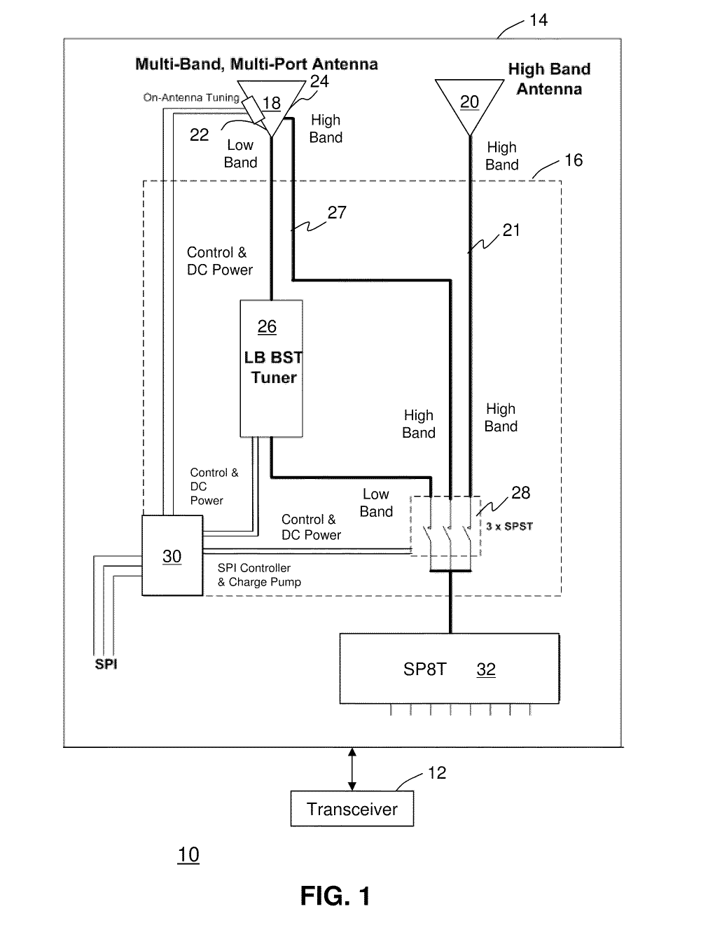

FIG. 1 depicts an exemplary embodiment of a multimode, multiband communication device 10 having a transceiver 12 and an antenna arrangement 14 or 16. The communication device 10 can include for example a multi-band or dual band antenna 18 that can reside at a bottom portion of the communication device 10 coupled to a communication circuit embodied as a transceiver 12, a low band tuner 26, a controller 30, and a switching mechanism 28. The switching mechanism 28 can be coupled to a front end switch 32 (such as a single pole, eight throw (SP8T) switch) of transceiver 12. The antenna arrangement 14 can be operable to radiate and/or receive signals in lower bands under 1000 MHz such as the in the 850 and 900 MHz band ranges and can also be designed to optionally operate (in one embodiment, receive only) in higher band ranges over 1500 MHz such as in the 1800 to 2100 MHz ranges. The antenna 18 can be coupled to a diversity receiver (not shown, but may be part of transceiver 12). The antenna 18 can include a low band port 22 coupled to a signal line from the low band tuner 26 and a high band port 24 selectively coupled to a signal line 27 via the switch mechanism 28. The communication device 10 can also include a multi-band antenna 20 that can reside at a top portion of the communication device 10 coupled to a communication circuit (such as multi-band transceiver 12 and switching mechanism 28), where the antenna 20 can be designed to radiate and/or receive signals in higher bands exceeding 1500 MHz and more likely ranging from 1700 to 2100 MHz. Thus, as used herein, “low band” refers to frequencies below 1000 MHz and “high band” refers to frequencies above 1500 MHz. An antenna is operational or operable in a frequency range if it is tuned to perform efficiently with the signals in the frequency range, and those skilled in that art will recognize that an antenna can be optimized to transmit and/or receive signals at one or more frequencies or bands where signals are communicated with a minimum signal strength as may be set in a specification. The antenna 20 can be selectively coupled to transceiver 12 via a high band signal line 21 and the switching mechanism 28. In one particular embodiment, the controller 30 can be a Serial Peripheral Interface (SPI) controller having a charge pump coupled to a SPI interface, the tuner 26 can be a low band tuner using ferroelectric materials such as barium strontium titanate (BST) variable capacitors, and the switching mechanism 28 can be a triple single pole, single throw switch. Another switch 32 of the transceiver 12 can be a single pole octal throw switch.

The transceiver 12 utilizes technology for exchanging radio signals with a radio tower or base station of a wireless communication system according to common modulation and demodulation techniques. Such techniques can include, but are not limited to, GSM, TDMA, CDMA, WiMAX, WLAN among others. The controller 30 utilizes computing technology such as a microprocessor and/or a digital signal processor with associated storage technology (such as RAM, ROM, DRAM, or Flash) for processing signals exchanged with the transceiver 12 and for controlling general operations of the communication device 10. The communication device 10 can separately include additional antennas at different locations such as a side antenna that can be a receive antenna in the range of 2100 MHz. Alternatively or optionally, the communication device can include a WLAN or Bluetooth antenna in operational range of 2440 MHz for example. The communication device 10 can also include a GPS antenna that operates in the range of 1575 MHz.

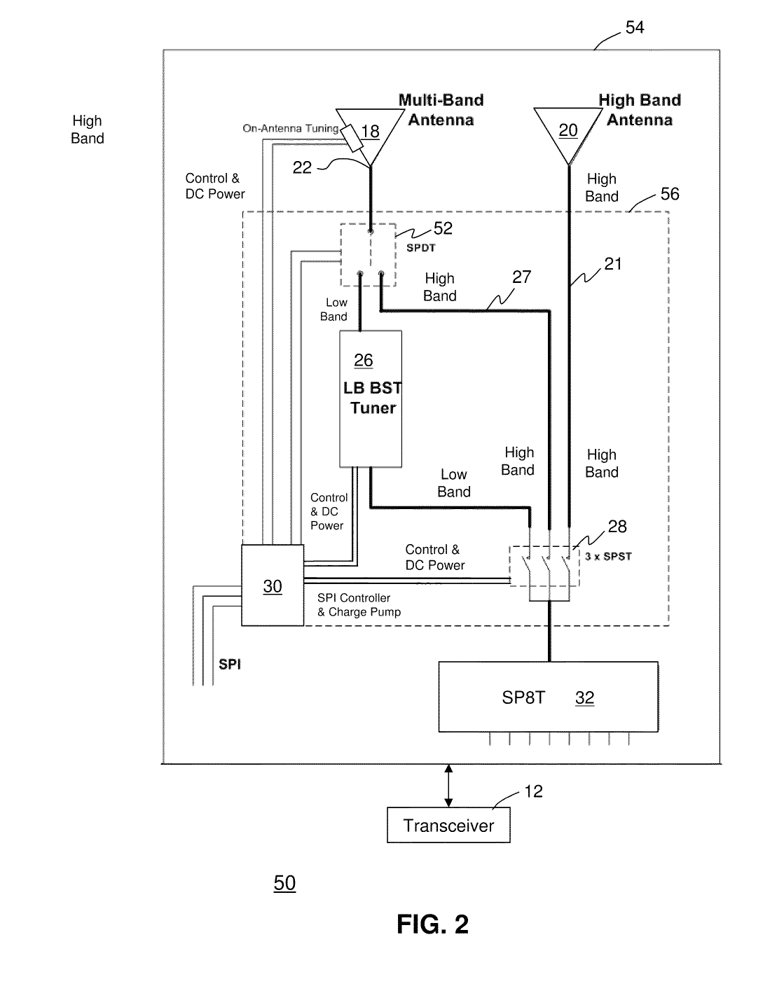

Referring to FIG. 2, a communication device 50 quite similar to the communication device 10 of FIG. 1 is shown. The communication device 50 primarily differs from the communication device 10 in that the communication device includes an antenna arrangement 54 or 56 that further includes a switch 52 as part of the switching mechanism to enable a selective connection to the multi-band antenna 18 from either the low band tuner 26 or the high band signal line 27. The switch 52 can be a single pole double throw switch as shown.

A main aspect of the embodiments involves an antenna arrangement that includes at least one low band antenna optimized by tuning in conjunction with using diversity with a high band antenna. In another aspect, the embodiments can determine a priori which pieces or portions of the spectrum a user is likely to use based on their geographic location and wireless carrier and then modify the antenna(s) to optimize operation of the antenna for the predetermined portions or pieces of the spectrum likely to be used.

With respect to the main aspect, the embodiments here hinge on an observation that the cause of loss of efficiency of an antenna due to a user can be attributed to predominantly impedance mismatch or resistive losses in user tissue and further recognizing that the lower bands' effects are typically include a significant contribution from impedance mismatch and the higher band effects are primarily due to resistive losses in the tissue. An antenna tuning and selection scheme as contemplated herein tunes the antennas impedance for operation at the low band and further uses an antenna selection scheme for the high band operation. Such an arrangement can reduce volume requirements as compared to an antenna selection scheme at low band, and can improve performance for the high band as compared to an antenna tuning scheme. Although antenna selection schemes and antenna tuning are both separately known techniques, utilizing both techniques as combined in the manner described is not known.

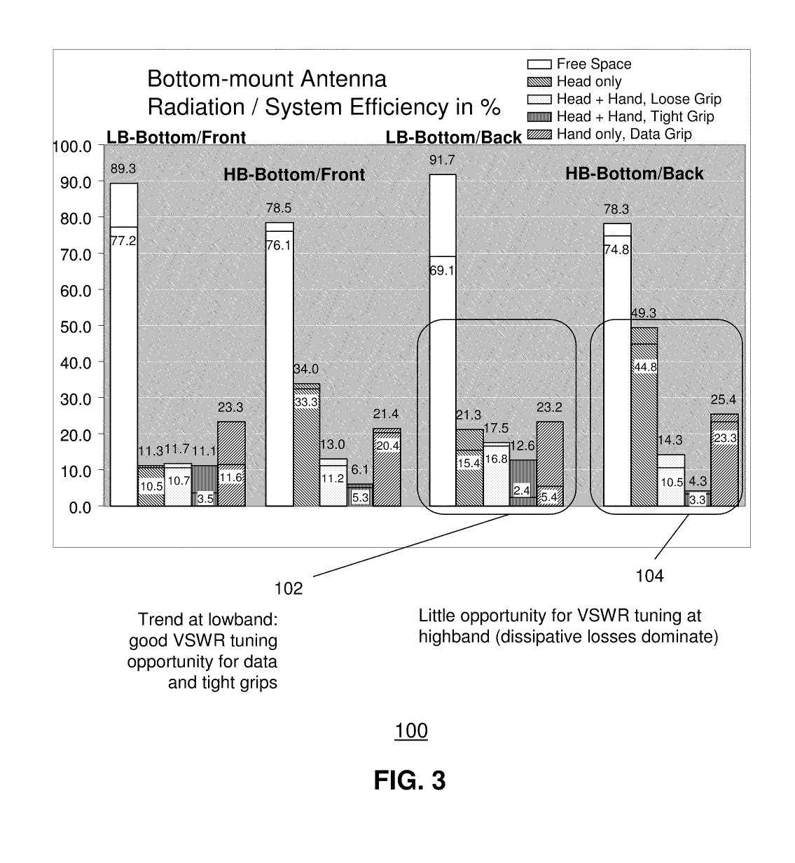

In combating hand effects, it is important to consider the two main mechanisms for loss of realized efficiency, absorption and mismatch, and the way in which these effects vary with frequency. The bar charts 100 of FIG. 3 illustrates what has been found to be a general trend for many types of antennas used on mobile devices. Two families of bar charts are shown, one for the low band and one for the high band. Within each family of bars, each bar represents one of five different use modes (like talk mode with loose grip, data mode with hand only, etc.). Each bar has two lines, the top one showing radiation efficiency, and the lower one showing system (realized) efficiency. (System or realized efficiency includes the negative effects of mismatch loss, whereas radiation efficiency includes only the effect of dissipative losses, assuming the antennas were perfectly matched.) From the low band family of curves, it can be seen that substantial degradation of system efficiency (e.g., the data mode use case) is due simply to mismatch loss (as evidenced by a large delta between radiation and system efficiencies). Hence, at the low bands, there is substantial opportunity for performance improvement just by implementing an adaptive voltage standing wave ratio or VSWR tuner on a single antenna as seen in section 102 of the bar graph.

On the other hand, from inspection of the high band family of curves as seen in section 104 of the bar graph, it is seen that there is little opportunity for improvement from a VSWR tuner (radiation and system efficiencies are nearly the same). At highband, the dominant loss mechanism is absorptive (dissipation in the tissue of the hand). These observations are consistent with the known current distributions of the antennas in the respective bands. At lowband, strong currents are distributed over the entire phone chassis, as it is small relative to a wavelength, while at highbands, the current distribution (while still involving the entire chassis) is more strongly localized to the antenna area. These facts lead to the greater opportunity for addressing hand impacts at the highband using redundant antennas, or more specifically adding a second antenna that is selected for use modes when the hand is covering the first antenna. In reference to the system efficiencies for two or more redundant antennas across two use cases it has been found that substantial benefit can be obtained at the high band via redundant antennas (that is, by selecting the antenna that is out of the user's hand in a given use mode).

In terms of implementation, the lowband VSWR tuner can be realized by monitoring reverse power and adjusting matching elements to maximize return loss or by selecting from a finite set of impedance match states based on the phone's knowledge that a user's hand is present, as may be determined for example by a proximity sensor. The users hand position may also be determined by other methods. For example, if the phone is being used to enter text on a QWERTY keypad a specific handgrip may be presumed. The highband antenna selection algorithm can choose one antenna or the other based on the phone's knowledge that it is in a voice call using the earspeaker (and thus against the user's head) or a data mode of operation (and thus in the user's hand(s)), or alternatively, the highband antenna selection algorithm can employ a more sophisticated algorithms monitoring, for example, received signal quality in a diversity system and selecting the antenna that produces the highest signal quality. When operating in the high band it is also possible for both antennas to be directly connected to separate high band receivers allowing for max ratio combining diversity to be implemented.

The proposed scheme can minimize added volume for the communication device. Since antenna size is inversely proportional to operating frequency, only a redundancy antenna is added at the high bands, where the required volume is less. The lowband (where antenna volume is approximately two times greater) is served by a single antenna as is common practice now. Thus, instead of volume, additional circuit complexity is added in the form of a tunable match which would take up less volume and provide more benefit than a second low band antenna.

Although most embodiments disclosed herein involve a dual band or multi-band antenna that covers both high and low bands and a separate high band antenna, Applicants contemplate within the scope of the claimed embodiments that 2 (or more) separate multi-band antennas can be implemented to provide low band and high band diversity or MIMO (Multiple Input, Multiple Output) if necessary. Note that two separate multi-band antennas that both cover low bands may require a larger volume configuration than an arrangement that has separate multi-band antennas where at least one of the antennas only covers high bands.

Although antenna systems are primarily designed for voice-centric devices, the more current devices shipping or being developed are not necessarily voice-centric. The market already demands devices that are optimized for SMS usage, for example QWERTY-optimized landscape-mode devices, and it can be anticipated that high-data-rate applications will also come to play a significant part in the user experience. Hence, in addition to supporting good radiated performance in the talking mode (device held to head at the ear), new designs should have high RF functionality when held in one or more data modes of operation (device held in one or both hands while viewing the display).

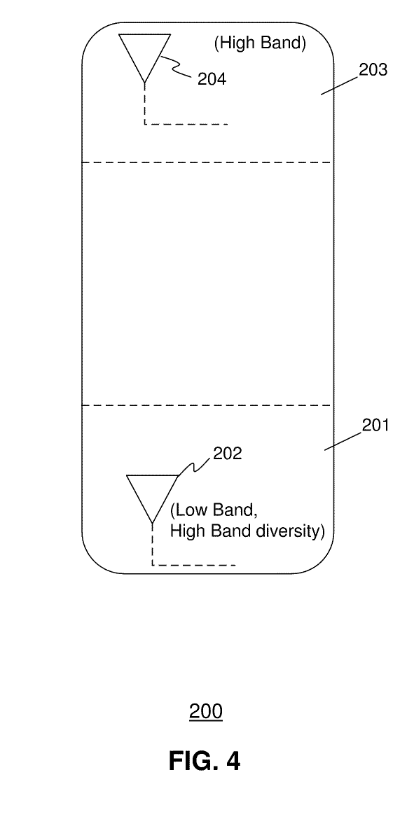

Current antenna architectures or platforms with the antenna located at the bottom of the phone are highly optimized for talk mode and rather disadvantaged for many data modes of operation. Embodiments herein provide an antenna architecture or arrangement that can support the necessary multiple, conflicting, use modes in a single device, while minimizing any volume, cost, and complexity added to the antenna system. Such an antenna system as shown in the communication device 200 of FIG. 4 can include an antenna 202 in a lower portion 201 of the communication device 200 and operable primarily in the low band ranges and optionally in the high band ranges for diversity while a top portion 203 of the communication device 200 can carry a separate antenna 204 for high band operation.

The positioning of the antenna can be arranged to be optimized for hand effects. Antennas located at the top of the phone or communication device tend to have less efficiency degradation due to a hand grip. For a given hand grip, the efficiency degradation is more severe in the higher frequency bands. Therefore the antenna serving the higher frequency band can be located at the top of the phone. The positioning of the antennas can also be arranged to to adjust Specific Absorption Rates or SAR. Antennas located at the bottom of a phone may have lower SAR. If the transmitter power is highest in one band, then the antenna serving the “higher power” band can be located at the bottom of the phone, so that SAR can be reduced to help meet government SAR regulatory requirements. Typically the transmitter power is highest in a low band. Therefore the antenna serving the lower frequency bands can be located at the bottom of the phone.

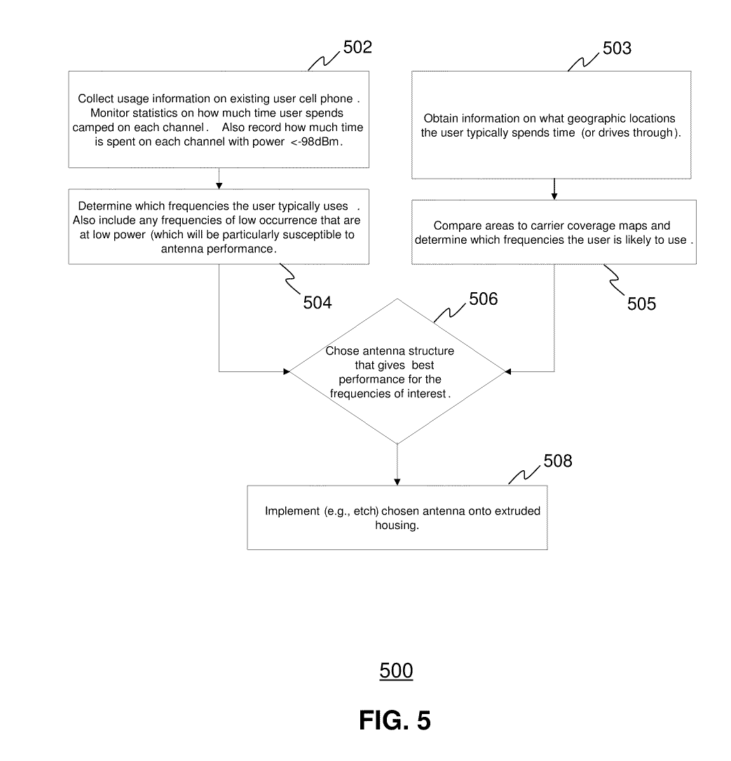

In yet another aspect of the embodiments herein, a manufacturer or user can select or implement an antenna or antenna arrangement that will be most optimal to a user's patterns of use. The selected antenna can be etched into an extruded housing or otherwise implement to allow the phone to be customized to enhance performance at the frequencies of most interest to a specific customer (or operator). This selection of optimized base antenna structure can preferably be done at the point of sale of the phone. In one embodiment 500 as shown in the flow chart of FIG. 5, usage information on an existing user's cell phone can be collected at 502. For example, statistics on how much time a user spends camped on each channel can be monitored. In one embodiment, the amount of time spent on each channel with a power less than −98 dBm can be recorded. At 504, the frequencies which the user typically uses can be determined and the frequencies of low occurrence that are at low power (which are particularly susceptible to antenna performance can also be determined.

Alternatively or optionally, the embodiment 500 can determine the typical areas the customer will use the phone based on collecting data on previous phones or inquiring which locations the customer will use the phone at 503. Based on the usage patterns, a carrier can compare with carrier coverage maps or otherwise determine which frequencies are mostly likely to be used at 505. At decision block 506, an antenna structure can be chosen that provides the best performance for the frequencies of interest. At 508, the optimal antenna chosen can be implemented for example by etching the antenna into the housing. Of course, implementation could also involve predetermined switch settings or tuning as contemplated herein.

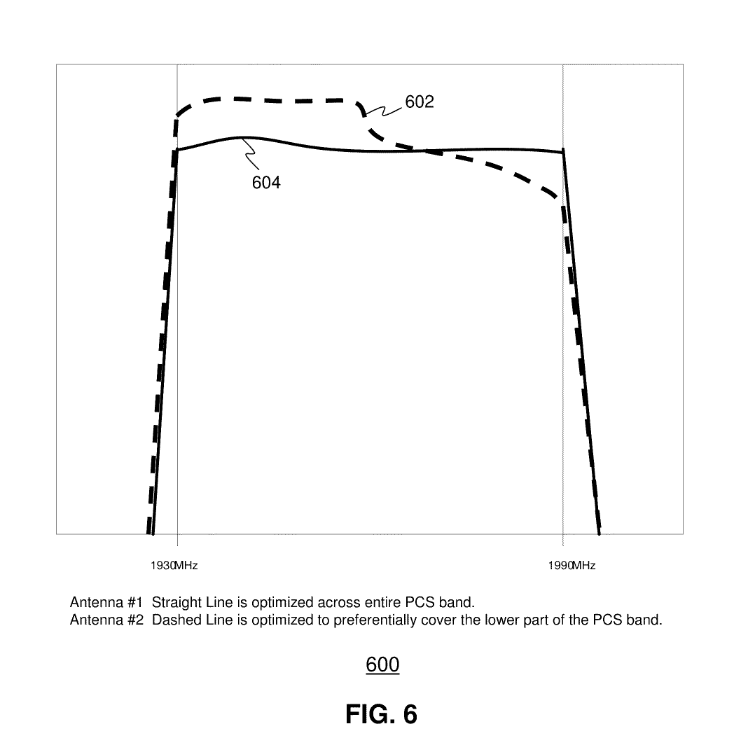

Antennas today are optimized to cover multiple bands, and attempt to cover all the bands equally as illustrated by the straight line 604 of the graph 600 of FIG. 6. Instead, it can be useful to optimize the antenna to preferentially cover portions of the bands the user is most likely going to use. For example, the dashed line 602 is optimized to preferentially cover the lower portion of the PCS band closer to the 1930 MHz range. Carriers (or operators) own a small subset of any band in a given region. (For example, the PCS band is divided into 6 sub bands A,B,C,D,E and F). Generally, antennas have been optimized to cover the entire frequency band, but for customers that use their phones predominantly in a specific location, optimizing the antenna for the frequency channels the customer will use will provide an improved experience in call performance and data throughput. Note that this a priori optimization can be combined with active tuning techniques such as closed-loop active tuning which can optimize on a per-channel basis within the capability of a given antenna configuration (banding). This can also be combined with diversity switching techniques as well.

As noted with respect to FIG. 1, the communication devices or arrangements can further include a Bluetooth or WLAN antenna as well as a GPS antenna if desired. The first antenna 18 and the second antenna 20 can reside on a keypad board of the wireless communication device 10 or 50. Note that the first antenna and the second antenna are separately located to provide spatial diversity in addition to the split band or frequency diversity. The wireless communication device can operate to switch phone operation between bands associated with the separately located antennas based on hand grip loading imposed on the antennas. Thus, the arrangements disclosed can also provide better call drop performance.

The configurations described herein can primarily provide for a multi-element multi-band internal antenna arrangement that can cover multiple GSM or UMTS bands (850 MHz, 900 MHz, 1700 MHz, 1800 MHz, 1900 MHz for example) and optionally both domestic and International WiMAX bands (2.5 GHz and 3.5 GHz). The arrangement can also cover the 2100 MHz band. Thus, the antenna configurations described can serve as a quad-band GSM dual band WiMax antenna or a Pentaband dual Band WiMax (or BlueTooth) antenna that can also separately include a GPS antenna for reception of GPS signals.

The antenna arrangement(s) can be made either of a sheet metal or can be insert molded using a 2-shot method. The antenna arrangement can comprise of any combination of loop antennas, folded dipoles, transmission lines, PIFA like elements, L-type stubs or other arrangements that provide the desired band operations and the requisite diversity and performance under various hand grip scenarios.

The foregoing embodiments of the antennas illustrated herein provide a multiband antenna design with a wide operating bandwidth where desired. The specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The embodiments herein are defined solely by the appended claims including any amendments made during the pendency of this application and all equivalents of those claims as issued.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An antenna arrangement for a multimode communication device, comprising:
a first antenna operational in a low band below 1000 MHz and in at least predetermined use modes in high bands above 1500 MHz;
a second antenna operational in the high bands;
a VSWR tuner coupled to the first antenna; and
a controller coupled to the VSWR tuner.

2. The antenna arrangement of claim 1, wherein the controller is operable to monitor reverse power on the first antenna and adjust matching elements to modify return loss to lower reflected power.

3. The antenna arrangement of claim 1 that includes a switching mechanism coupled to the first and second antennas for selecting between the first antenna and the second antenna, wherein the controller is operable to monitor the predetermined use modes of the multimode communication device among voice mode and data mode wherein the mode of use determines the operation of the switching mechanism.

4. The antenna arrangement of claim 1, wherein expected pieces of spectrum a user is expected to operate on are considered and at least one of the first and second antennas is modified to improve performance in the expected pieces of spectrum.

5. The antenna arrangement of claim 4, wherein the expected pieces of spectrum are those used by a user's wireless carrier in the vicinity of at least one of a user's home and a user's place of employment.

6. The antenna arrangement of claim 3, wherein the controller is operable to monitor earspeaker and data modes of the multimode communication device to determine the use mode.

7. The antenna arrangement of claim 3, wherein the controller is operable to monitor signal quality via the first and second antenna to determine the use mode.

8. The antenna arrangement of claim 3, wherein the switch mechanism switches between the VSWR tuner, the first antenna, and the second antenna.

9. The antenna arrangement of claim 3, wherein the switch mechanism comprises a triple single pole, single throw switch that switches among the VSWR tuner, the first antenna, and the second antenna and further comprises a single pole double throw switch that switches the first antenna between the VSWR tuner and a high band signal processing line

10. The antenna arrangement of claim 1, wherein the first antenna and the second antenna are both folded J antennas (FJAs).

11. The antenna arrangement of claim 1, wherein the first antenna is located at a bottom portion of the multimode communication device and the second antenna is located at a top portion of the multimode communication device.

12. A multimode communication device having an antenna arrangement, comprising:
at least one of a transmitter or a receiver;
a first antenna operational in both low bands and high bands;
a second antenna operational in high bands;
a tuner coupled to the first antenna adapted to adjust matching elements to modify return loss to lower reflected power;
a switching mechanism for selecting between the first antenna and the second antenna for operation with said at least one of a transmitter and receiver; and
a controller coupled to the switching mechanism and the tuner.

13. The multimode communication device of claim 12, wherein said at least one of a transmitter and a receiver comprises a multimode, multi-band transceiver coupled to the switching mechanism.

14. The multimode communication device of claim 12, wherein the controller is operable to monitor reverse power on the first antenna and adjust matching elements to modify return loss to lower reflected power and the controller is further operable to monitor a mode of operation of the multimode communication device among voice mode using an earspeaker and data mode of operation in a user's hand to determine the operation of the switching mechanism.

15. The multimode communication device of claim 12, wherein the first antenna adapts to user hand interaction by VSWR tuning of the first antenna and the second antenna adapts to user hand interaction by switching based on mode of use and wherein the switch mechanism switches between a VSWR tuner, the first antenna, and the second antenna.

16. The multimode communication device of claim 12, wherein the switch mechanism comprises a triple single pole, single throw switch.

17. The multimode communication device of claim 12, wherein the switch mechanism comprises a triple single pole, single throw switch that switches among the tuner, the first antenna, and the second antenna and further comprises a single pole double throw switch that switches the first antenna between the tuner and a high band signal processing line.

18. An antenna arrangement for a multimode communication device, comprising:
a tuner coupled to a first antenna adapted to adjust matching elements to modify return loss to lower reflected power, wherein the antenna is operational in both low bands and high bands;
a switching mechanism for selecting between the first antenna and a second antenna, wherein the second antenna is operational only in high bands; and
a controller coupled to the switching mechanism and the tuner.

19. The antenna arrangement of claim 18, wherein the controller is a serial peripheral interface (SPI) controller having a charge pump, the tuner is a low band Barium Strontium Titinate (BST) voltage standing wave ratio (VSWR) tuner, and the switching mechanism at least switches towards the VSWR tuner, the first antenna, and the second antenna using triple single pole, single throw switch.

20. The antenna arrangement of claim 18, wherein tuner is coupled or selectively coupled to a low band antenna port of the first antenna.
